(19) United States
(12) Patent Application Publication
(10) Pub. No.: US 2026/0010736 A1
(43) Pub. Date: Jan. 8, 2026

(54) LANGUAGE MODEL ASSISTED HUMAN-TO-COMPUTER INTERACTION

(71) Applicant: GOOGLE LLC, Mountain View, CA (US)

(72) Inventors: Carsten Isert, Zurich (CH); Martin Baeuml, Wollerau (CH)

(21) Appl. No.: 19/139,235

(22) PCT Filed: Dec. 15, 2023
(86) PCT No.: PCT/US2023/084398

§ 371 Date: Jun. 13, 2025

Related U.S. Application Data
(60) Provisional application No. 63/433,415, filed on Dec. 16, 2022.

(51) Int. Cl. G06F 40/40

(52) U.S. Cl. CPC G06F 40/40

(57) ABSTRACT

Implementations provide a method that includes: receiving a user input from a particular user; generating, based on attribute information provided by the particular user, an attribute embedding that numerically represents, but does not reveal, the attribute information of the particular user; processing, using a language model, both the attribute embedding and the user input to generate a language model output; generating, based on the language model output, a response to the user input; and causing the generated response to be rendered at the client device in response to the user input from the particular user.

### BACKGROUND

Humans can engage in human-to-computer dialogs with interactive software applications referred to herein as “automated assistants” (also referred to as “chatbots,” “interactive personal assistants,” “intelligent personal assistants,” “personal voice assistants,” “conversational agents,” or simply “assistant,” etc.). For example, humans (sometimes referred to as “users” when they interact with automated assistants) may provide commands or requests to an automated assistant, using user input such as spoken natural language input (e.g., spoken utterances, which may be converted into text and then processed) or textual (e.g., typed) natural language input. An automated assistant generally responds to a command or request from a user by providing user interface output (e.g., audible and/or graphical user interface output), controlling smart device(s), and/or performing other action(s), that are responsive to the command or request.

However, during a human-to-computer dialog, the automated assistant may not robustly adapt user interface output or actions based on attribute(s) of the user, such as temporary and/or persistent attributes that the user has provided in their profile and/or attributes that are inferred from the user's command(s), request(s), and/or other interactions with the automated assistant.

Put another way, the automated assistant may not adapt user interface output that it provides in dependence on attribute(s) of a user that is engaged in a human-to-computer dialog session with the automated assistant. This leads to the automated assistant generating user interface output that fails to resonate with the user, which can inhibit the user's ability to comprehend such output. This can additionally or alternatively prolong the human-to-computer dialog session, as additional user input can be needed to confirm an intent of the user. A prolonged human-to-computer dialog session between the user and a client device (via which the dialog session occurs) can cause excess utilization of battery, processor, and/or other resources of the client device.

### SUMMARY

Implementations disclosed herein relate to utilizing a language model (e.g., a large language model (LLM)) to facilitate human-to-computer dialog(s) between a user and an interactive software application (e.g., an “automated assistant”) that is installed at, or accessible via, a client device. In those implementations, the user can provide, during a human-to-computer dialog, a natural language user input (spoken or textual) to the automated assistant. The automated assistant can generate, based on text of the natural language user input, a responsive user interface output for rendering (e.g., audible and/or visual) by the automated assistant and/or a responsive action to be performed by, or initiated by, the automated assistant.

Further, implementations disclosed herein seek to ensure the responsive user interface output and/or the responsive action resonate with the user. In doing so, the automated assistant generates the responsive user interface output and/or the responsive action further based on attribute information of the user that is engaged in the human-to-computer dialog. The attribute information is utilized with permission from the user, and can include attribute information that is based on attribute(s) explicitly specified by the user (e.g., in a user profile) in advance of the human-to-computer dialog and/or that is based on attribute(s) inferred from the human-to computer dialog and/or from prior human-to-computer dialog(s) that involve the user. In some of those implementations, an attribute embedding can be generated based on the attribute information, and the attribute embedding is used by the automated assistant in generating the responsive user interface output and/or the responsive action. The attribute embedding can be used in generating the responsive user interface output and/or the responsive action, and can be used independent of any use of the underlying attribute information that is utilized in generating the attribute embedding. Further, the attribute embedding can numerically represent, but not reveal, the underlying attribute information based on which it is generated. In these and other manners, utilization of the attribute embedding enables generation of responses that resonate with a given user and/or enable more efficient (e.g., quicker) resolution of an interaction with a given user, while maintaining user privacy and/or security of user data. For example, the attribute embedding can be effectively utilized in processing performed utilizing the LLM, but does not reveal underlying attribute information on which it is generated.

In various implementations, the automated assistant can generate language model output based on processing, using an LLM, both (a) a current attribute embedding for the user involved in the human-to-computer dialog and (b) a most recent instance of natural language user interface input from the user. Further, the automated assistant can generate the responsive user interface output and/or the responsive action based on the language model output. Optionally, in generating the language model output, additional data can be processed using the LLM and along with (a) the current attribute embedding and (b) the most recent instance of natural language user input. For example, the additional data that is processed can be based on a conversation history from the human-to-computer dialog. For instance, it can include prior response(s) from the automated assistant and/or prior natural language user input(s) from the user.

In some implementations, in generating language model output based on processing both (a) the current attribute embedding and (b) the most recent instance of natural language user input from the user, (a) the current attribute embedding is processed (optionally along with additional data), using the LLM, to prime the LLM, and (b) the most recent instance of natural language user input is then processed using the LLM. For example, (a) the current attribute embedding and (b) the most recent instance of natural language user input can be concatenated into a continuous string, and that continuous string processed using the LLM. In some of those implementations, the language model output that is generated after processing (b) the most recent instance of natural language user input can be the language model output based on which a responsive user interface output and/or a responsive action is generated.

As referenced above, processing (a) the current attribute embedding utilizing the LLM can ensure the responsive user interface output and/or the responsive action resonate with the user. As one non-limiting example, assume a natural language user input of “I'm bored” is provided to an automated assistant. When the natural language user input is processed using the LLM and along with a first attribute embedding, a first language model output can be generated. In this non-limiting example, the first attribute embedding can be, for instance, an age embedding generated based on previous user input (e.g., 1 min ago in the same human-to-computer dialog of the natural language user input, or from a different dialog) indicating that a user is in their early 20s, generated based on voice features of a spoken utterance from which the natural language user input is recognized, or generated based on one or more terms (e.g., youth language or old-fashioned words), from the natural language user input, that indicate age information. It's noted that the first attribute embedding does not necessarily need to be an age embedding, but can include an embedding of additional or alternative type(s) of attributes, such as a hobby embedding generated based on a user profile indicating that the user is a music fan. Further, a first response can be generated and implemented by the automated assistant based on the first language model output, such as a first textual or audible recommendation (e.g., “wanna hear the song X? I believe it's one you might like”, where the song X is a popular song among people in their early 20s and thus recommended to the user in his early 20s) and/or a first action (e.g., an action that causes playing of “song X”). The music focused first response can be based in part on processing of the first attribute embedding and based on the first attribute embedding indirectly reflecting interest in music.

Continuing with the non-limiting example above, when the natural language user input is instead processed using the LLM and along with a distinct second attribute embedding (e.g., a weekly routine embedding generated based on the calendar data shared by the user, which indicates that the user plays trivia with a group of friends every Saturday night), a distinct second language model output can instead be generated. Further, a second response can be generated and implemented by the automated assistant based on the second language model output, such as a second textual or audible recommendation (e.g., “want to play some trivia?”) and/or a second action (e.g., an action that causes launching of a trivia application). The trivia focused second response can be based in part on processing of the second attribute embedding and based on the second attribute embedding indirectly reflecting interest in trivia.

As referenced above, the attribute information that is utilized in generating an attribute embedding can include attribute information that is based on attribute(s) explicitly specified by the user (e.g., in a user profile) in advance of a human-to-computer dialog and/or that is based on attribute(s) inferred from the human-to computer dialog and/or from prior human-to-computer dialog(s) that involve the user.

As one particular example, an initial attribute embedding can be generated for a user based on attribute information, from a user profile of the user, for which the user has provided permission to utilize. For example, the attribute information can include a particular age or an age range of the user, a geographical region for the user, a gender of the user, explicitly indicated preference(s) of the user, and/or other attribute information of the user. For instance, such attribute information can be processed using a neural network encoder and final or intermediate output, of the encoder and generated based on the processing, can be used as the initial attribute embedding. The initial attribute embedding can be used in one or more iterations of generating an automated assistant response as described herein and/or can be iteratively updated over time (e.g., as described below) and respective updated attribute embeddings used in iteration(s) of generating an automated assistant response as described herein.

In some implementations, the initial attribute embedding can be updated over time for the user based on attribute(s) inferred from past or current human-to computer dialog(s) engaged in by the user. The updating over time can occur iteratively during a given human-to-computer dialog session and/or can occur across multiple human-to-computer dialog sessions (e.g., iteratively updated during a first session, then continue to be iteratively updated during a second session). In some of those implementations, the initial attribute embedding is updated by determining a dialog attribute embedding associated with a dialog engaged in by the user, and adapting the initial attribute embedding so that it moves closer, distance-wise in embedding space, to the dialog attribute embedding. For example, assume the dialog engaged in by the user is about music. A dialog attribute embedding can be determined based on processing, using the neural network encoder, attribute information that reflects interest in music, and final or intermediate output of the encoder used as the dialog attribute. Further, the adapted attribute embedding can be generated as an average (weighted or unweighted) of the initial attribute embedding and the dialog embedding. Additionally or alternatively, the dialog attribute embedding can be determined as a function of attribute embeddings for a population of users that engaged in the same or similar dialogs about music. In those additional or alternative scenarios, the adapted attribute embedding can likewise be generated as an average of the initial attribute embedding and the dialog embedding. In these and other manners, an initial attribute embedding of a user can be updated, or further updated, by moving it closer to dialog embedding(s) derived from human-to-computer dialog(s) that involve the user. Such updating is performed without reprocessing of attribute information utilizing an encoder model or other model for generating attribute embeddings. In addition to such updating being computationally efficient, it can further ensure that updated embeddings do not directly reveal underlying attribute information that is reflected by such updated embeddings.

As another particular example, instead of being generated based on attribute information of a user, an initial attribute embedding for a user can be a default attribute embedding or a randomly selected attribute embedding, such as one that is randomly selected from a distribution around a default attribute embedding. Further, such a default or randomly selected initial attribute embedding can be updated over time for the user based on attribute(s) inferred from past or current human-to computer dialog(s) engaged in by the user. In some implementations, the default or randomly selected attribute embedding can be used as an initial attribute embedding in response to determining that no attribute information has been provided by the user and/or shared by the user with the automated assistant.

As yet another particular example, an initial attribute embedding for a user can be generated based on attribute(s) inferred from input(s) of a user during a current human-to computer dialog(s) engaged in by the user.

The language model (e.g., LLM) that is utilized in implementations disclosed herein can be trained to generate language model output that is dependent on at least an attribute embedding and an instance of natural language input. For example, an LLM can be trained at least in part on training instances that each include: corresponding training instance input, with at least a corresponding attribute embedding and a corresponding instance of natural language input, and a corresponding ground truth training instance response.

As one particular example, a training instance can be generated based on a chat exchange, email exchange, or other communication exchange between at least two human users. For instance, training instance input for the training instance can include natural language input provided by a first of the users in the communication exchange and can include an attribute embedding generated based on attribute information of the first of the users. The training instance output for the training instance can include natural language input provided by a second of the users in the communication exchange and responsive to the natural language input of the training instance input. Utilizing such a training instance (and a large quantity of additional similar training instances) leverages that the second users' response will be adapted to the attribute information of the first of the users, enabling the language model to be trained such that language model output is likewise generated according to attribute information of a user that is engaging in a human-to-computer dialog. For example, assume the natural language input provided by the first user is “any suggestions for a fun activity around town?”. The second users' response to that input would vary significantly in dependence on attribute information of the first user. For example, a first response would be provided if the first user was a young professional in a major metropolitan area as opposed to if the first user were instead elderly and in a remote rural area.

As another particular example, a training instance can be generated based on all or portion(s) of a webpage that are attributable to a particular author. For instance, the training instance input for the training instance can include natural language input that is generated based on a first portion of natural language in a webpage that is attributable to a given author and can include an attribute embedding generated based on attribute information of the given author. The training instance output can include natural language input that conforms to a second portion of the natural language, such as a second portion that immediately follows the first portion. For instance, the first portion can be a first sentence and the natural language input of the training instance input can conform to the first portion or can be a rephrasing of the first portion. Further, the second portion can conform to a second sentence that immediately follows the first sentence. Utilizing such a training instance (and a large quantity of additional similar training instances) leverages that the different portions crafted by the author will each be adapted to the attribute information of the author, enabling the language model to be trained such that language model output is likewise generated according to attribute information of a user that is engaging in a human-to-computer dialog.

In some implementations, an LLM can include at least hundreds of millions of parameters. In some of those implementations, the LLM includes at least billions of parameters, such as two billion or more parameters or one hundred billion or more parameters. In some additional or alternative implementations, an LLM is a sequence-to-sequence model, is Transformer-based, includes attention mechanism(s), and/or can include an encoder and/or a decoder (e.g., a decoder-only based model). One non-limiting example of an LLM is GOOGLE'S Pathways Language Model (PaLM). Another non-limiting example of an LLM is GOOGLE'S Language Model for Dialogue Applications (LaMDA).

The above is provided merely as an overview of some implementations. Those and/or other implementations are disclosed in more detail herein.

Various implementations can include a non-transitory computer readable storage medium storing instructions executable by a processor to perform a method such as one or more of the methods described herein. Yet other various implementations can include a system including memory and one or more hardware processors operable to execute instructions, stored in the memory, to perform a method such as one or more of the methods described herein.

### BRIEF DESCRIPTION OF THE DRAWINGS

The above and other aspects, features, and advantages of certain implementations of the present disclosure will be more apparent from the following description taken in conjunction with the accompanying drawings. In the drawings:

FIG. 1 depicts a block diagram of an example environment that demonstrates various aspects of the present disclosure, and in which implementations disclosed herein can be implemented.

FIG. 2A depicts an example process of utilizing a language model in assisting a human-to-computer dialog, in accordance with various implementations.

FIG. 2B depicts another example process of utilizing a language model in assisting a human-to-computer dialog, in accordance with various implementations.

FIG. 2C depicts yet another example process of utilizing a language model in assisting a human-to-computer dialog, in accordance with various implementations.

FIG. 3A depicts another example process of utilizing a language model in assisting a human-to-computer dialog, in accordance with various implementations.

FIG. 3B depicts an enlarged view of a user interface in FIG. 3A, in accordance with various implementations.

FIG. 4A illustrates a flowchart illustrating an example method of utilizing a language model in assisting human-to-computer dialog(s), in accordance with various implementations.

FIG. 4B illustrates a flowchart illustrating an example method of generating an attribute embedding in FIG. 4A, in accordance with various implementations.

FIG. 5 is a flowchart illustrating another example method of utilizing a language model in assisting human-to-computer dialog(s), in accordance with various implementations.

FIG. 6 illustrates an example architecture of a computing device, in accordance with various implementations.

### DETAILED DESCRIPTION

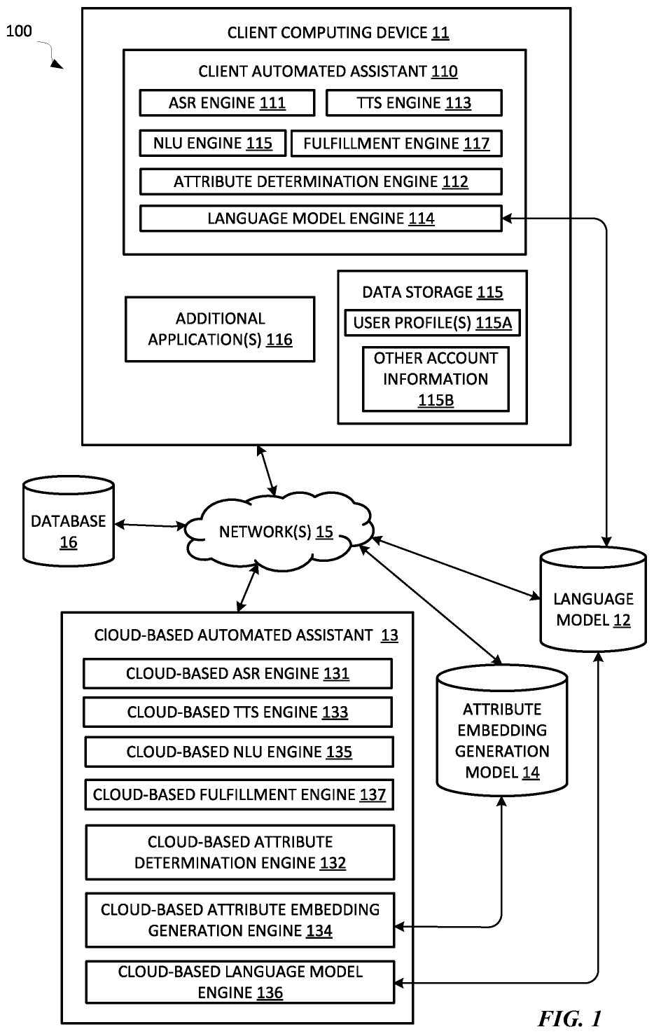

FIG. 1 is a block diagram of an example environment 100 that demonstrates various aspects of the present disclosure, and in which implementations disclosed herein can be implemented. As shown in FIG. 1, the environment 100 can include a client computing device 11 (also referred to herein as “client device”) that includes a client automated assistant 110, additional application(s) 116, and/or data storage 115. The client computing device 11 can be in communication with one or more servers via one or more networks 15. For instance, the server(s) can include server(s) that implement a cloud-based automated assistant application 13 (or certain components thereof), and the client automated assistant application 110 can communicate with the cloud-based automated assistant application 13 via the one or more networks 15. The client automated assistant application 110 and/or the cloud-based automated assistant application 13 may be referred to herein as an “automated assistant”.

The client computing device 11 can be, for example, a cell phone, a laptop, a desktop, a notebook computer, a tablet, a smart TV, a messaging device, or a personal digital assistant (PDA), and the present disclosure is not limited thereto. The one or more servers can include, for example, a cluster of high-performance computing devices. The one or more networks 15 can include, for example, a local area network (LAN), a wide area network (WAN) such as the Internet, and/or any other appropriate network. The additional application(s) 116 can include, a social media application, a music application, a messaging application, and/or other application(s) that are different from the client automated assistant 110, but that are accessible or installed at the client computing device 11.

In various implementations, the client automated assistant application 110 can have a plurality of components, including: an automatic speech recognition (ASR) engine 111, a text-to-speech (TTS) engine 113, a natural language understanding (NLU) engine 115, and/or a fulfillment engine 117. The plurality of components can further include, for example, an attribute determination engine 112, and/or a language model engine 114.

In various implementations, the cloud-based automated assistant application 13 can have a plurality of cloud-based components, including: a cloud-based automatic speech recognition (ASR) engine 131, a cloud-based text-to-speech (TTS) engine 133, a cloud-based natural language understanding (NLU) engine 135, a cloud-based fulfillment engine 137, a cloud-based attribute determination engine 132, a cloud-based attribute embedding generation engine 134, and/or a cloud-based language model engine 136. Each of the plurality of cloud-based components can have same or similar functions as their counterpart at the client computing device 11. For instance, a cloud-based component (e.g., the cloud-based ASR engine 131) of the plurality of cloud-based components can be trained more extensively or possess stronger processing capability, but have the same functions, as a corresponding local component (e.g., the ASR engine 111) at the client computing device 11. While not illustrated in FIG. 1 for simplicity, the client automated assistant application 110 can also include an attribute embedding generation engine.

The ASR engine 111 can process audio data that captures a spoken utterance to generate a speech recognition of the spoken utterance. The NLU engine 115 can determine semantic meaning(s) of audio (e.g., the aforementioned audio data capturing the spoken utterance) and/or a text (e.g., natural language content from a message or the aforementioned speech recognition that is converted by the ASR engine 111 from the audio data), and decompose the determined semantic meaning(s) to determine intent(s) and/or parameter(s) for an assistant action. For instance, the NLU engine 115 can process natural language content of “Weather today in Louisville?”, to determine an intent (e.g., Internet search) and/or parameters (e.g., search parameters including: “weather”, “today”, and “Louisville”, or “Weather today in Louisville?”) for an assistant action (e.g., search the Internet for the weather in Louisville today).

In some implementations, the NLU engine 115 can resolve the intent(s) and/or parameter(s) based on a single utterance of a user and, in other situations, prompts can be generated based on unresolved intent(s) and/or parameter(s). In this latter situation, the generated prompts can be rendered to the user to receive user response(s), where the user response(s) to the rendered prompt(s) can be utilized by the NLU engine 115 in resolving intent(s) and/or parameter(s). Optionally, the NLU engine 115 can work in concert with a dialog manager engine (not illustrated) that determines unresolved intent(s) and/or parameter(s). For instance, the dialog manager engine can be alternatively or additionally utilized to generate the aforementioned prompt(s). In some implementations, the NLU engine 115 can utilize one or more NLU machine learning models in determining intent(s) and/or parameter(s).

In some implementations, the NLU engine 115 can be fully omitted and the language model engine 114 utilized in lieu of the NLU engine 115. In some other implementations, the NLU engine 115 and the language model engine 114 can both be provided. In some of those other implementations, the NLU engine 115 and the language model engine 114 can optionally both process at least some user inputs in parallel, and responsive output from one of the two utilized in fulfilling the user input. For example, some inputs can be resolved utilizing output from the NLU engine 115 and other inputs can be resolved utilizing output from the language model engine 114.

In various implementations, the fulfillment engine 117 of the client automated assistant application 110 can receive an intent and/or parameter(s) of the intent, to fulfill the intent by performing a corresponding assistant action. The intent and/or parameter(s) of the intent can be received from the NLU engine 115 or from the language model engine 114. As a non-limiting example, the fulfillment engine 117 can receive the aforementioned intent of Internet search and the aforementioned search parameter of “Weather today in Louisville?”, to cause a search engine of the client computing device 11 to search the Internet for “Weather today in Louisville?”. In this example, the fulfillment engine 117 can fulfill the intent by: (1) causing the search engine to search the Internet for the user query, i.e., “Weather today in Louisville?”), (2) generating fulfillment information (e.g., “it's cloudy outside, with a temperature of 26.C”), based on a search result (e.g., “Louisville, KY, Monday 11:00 am, cloudy, 26·C”) of the search, and/or (3) rendering the fulfillment information to the user of the client computing device 11. As another non-limiting example, the fulfillment engine 117 can receive an intent and/or parameter(s) for an assistant action that causes a thermostat in the living room to set room temperature at 72 F. In this example, the fulfillment engine 117 can fulfill the intent by generating and forwarding a control signal to the thermostat in the living room, where the control signal causes the thermostat to set the room temperature at 72 F.

In some implementations, the TTS engine 113 can convert text (e.g., the aforementioned fulfillment information of “it's cloudy outside, with a temperature of 26.C”) to synthesized speech. The synthesized speech, for instance, can be generated by using one or more trained speech synthesis neural network models to process the text (e.g., processing phonemes determined from the text). The synthesized speech can be audibly rendered via hardware speaker(s) of the client computing device 11 (e.g., a stand-alone speaker) or via another device (e.g., a cell phone). While the above are illustrated using one or more components (e.g., the ASR engine 111) of the client automated assistant 110, same or similar functions, processes, or features can be implemented using counterpart component(s) of the cloud-based automated assistant 13.

In various implementations, the attribute determination engine 112 (or the cloud-based attribute determination engine 132) can retrieve or determine attribute information from one or more sources (e.g., user input, user profile, user account, publicly accessible database, etc.). In some implementations, the attribute determination engine 112 can determine some or all attribute information based on user input(s). Alternatively or additionally, the attribute determination engine 112 can determine some or all of the attribute information from a user profile (or other data authorized by a user) to which the automated assistant has access.

As a non-limiting example, a user input can be a spoken utterance from a particular user, and based on a voice of the particular use reflected by such spoken utterance, the attribute determination engine 112 can estimate an age of the particular user, and/or can estimate a gender of the particular user. In this instance, the attribute determination engine 112 can include the estimated age and/or gender, of the particular user, in the attribute information, for use in generating an attribute embedding that numerically represents, but does not reveal, the attribute information of the particular user. The attribute embedding, for instance, can be in the form of a N-dimensional vector represented by N numerical components. In this instance, an attribute embedding generated for attribute information of “age 46, female” can be closer to an attribute embedding generated for attribute information of “age 47, female” than is an attribute embedding generated for attribute information of “age 27, male”. It is noted that the attribute information determined from the voice of the spoken utterance can additionally or alternatively include other information, such as dialect.

As another non-limiting example, the user input can be a spoken or typed input from the user, such as input “I was born in the 1980s”. Based on such user input (e.g., “I was born in the 1980s”), the attribute determination engine 112 can determine the attribute information of the user to include: an age (e.g., late 30s to early 40s) determined or estimated for the user. The attribute embedding generation engine 134 (or counterpart implemented locally at the client device 11) can generate, based on the determined attribute information (e.g., the determined or estimated age) of the user and/or based an initial attribute embedding, an attribute embedding that numerically represents, but does not reveal, the attribute information of the user.

An initial attribute embedding can be but does not necessarily need to be specific to the user. For example, the initial attribute embedding can be generated as a final output (or an intermediate output) of an attribute embedding generation model 14 which processes attribute information of the user that is extracted from a user account of the particular user, as input. As another example, the initial attribute embedding can be generated as a final output (or an intermediate output) of an attribute embedding generation model 14 which processes attribute information characterizing a group of users, as input, where the group of users can include but does not necessarily include the particular user. In this instance, the attribute information characterizing the group of users can be from, e.g., a database 16, that stores or indexes publicly accessible posts, articles, or other data relating to attribute information of public users. The attribute embedding generation model 14, for instance, can be a neutral network model such as a neural network encoder.

Continuing with the above non-limiting example, the client automated assistant 110 can receive an additional typed input (e.g., “I started to wear corrective lenses to treat nearsightedness about 10 years ago”), subsequent to the typed input (e.g., “I was born in the 1980s”). In this case, the attribute determination engine 112 can determine updated attribute information (e.g., late 30s to early 40s, nearsighted) of the user. Correspondingly, the attribute embedding generation engine (or its counterpart 134) can generate, based on the updated attribute information (e.g., late 30s to early 40s, nearsighted) of the user and/or the attribute embedding, an additional/updated attribute embedding that numerically represents, but does not reveal, the updated attribute information of the particular user.

Alternatively or additionally, the attribute information can be from source(s) other than the user input. For instance, the attribute information of the particular user can be from account information 115B of the client automated assistant 110 (or other application) stored in the data storage 115, a user profile 115A of the client computing device 11 stored in the data storage 115, or other source(s) not illustrated in FIG. 1 (e.g., emails, text or other information authorized by the particular user as being accessible by the client computing device 11 or application(s) installed at the client computing device 11).

In various implementations, the language model engine 114 can access and use a language model 12 (e.g., an LLM), to process both the attribute embedding (or the aforementioned additional attribute embedding) and the user input, to generate a corresponding language model output. Alternatively, in various implementations, the user input (e.g., spoken utterance) can be processed to generate a natural language representation of the user input, and the language model engine 114 can access and use the language model 12 (e.g., LLM), to process both the attribute embedding and the natural language representation of the user input, to generate a corresponding language model output.

Based on the corresponding language model output, the automated assistant can generate a response to the user input, and cause the generated response to be rendered at the client device in response to the user input.

In some implementations, the language model engine 114 can process both the attribute embedding and the user input (textual or audible) by: processing, using the language model, the attribute embedding to prime the language model; and processing, using the primed language model, the user input to generate the aforementioned language model output. Based on the language model output, the client automated assistant 110 can, for instance, use the fulfillment engine 117, to generate a response/statement responsive to the user input, or to suggest content (or action(s)) to the user responsive to the user input.

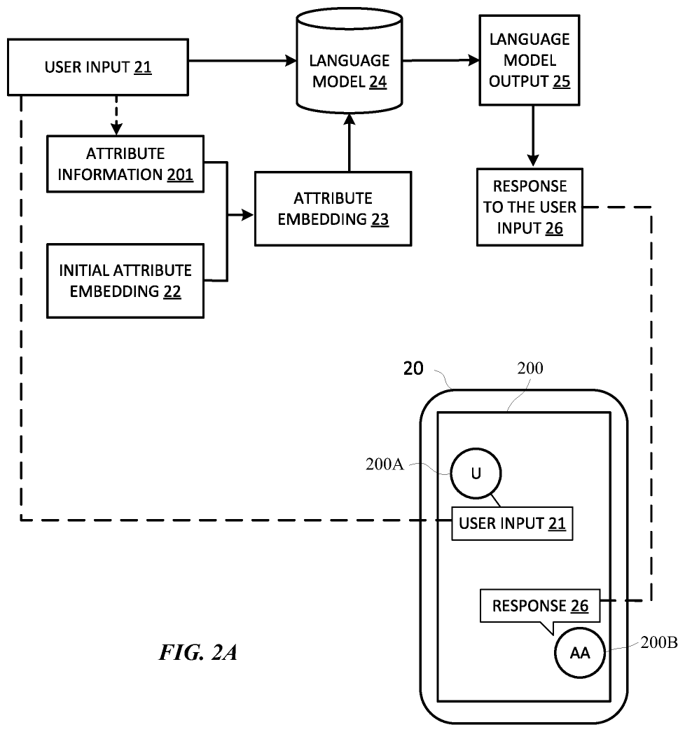

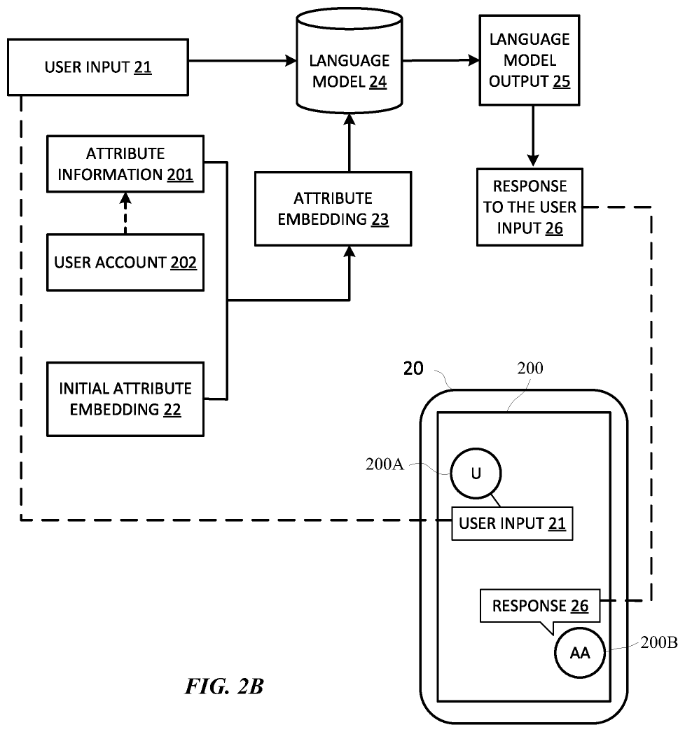

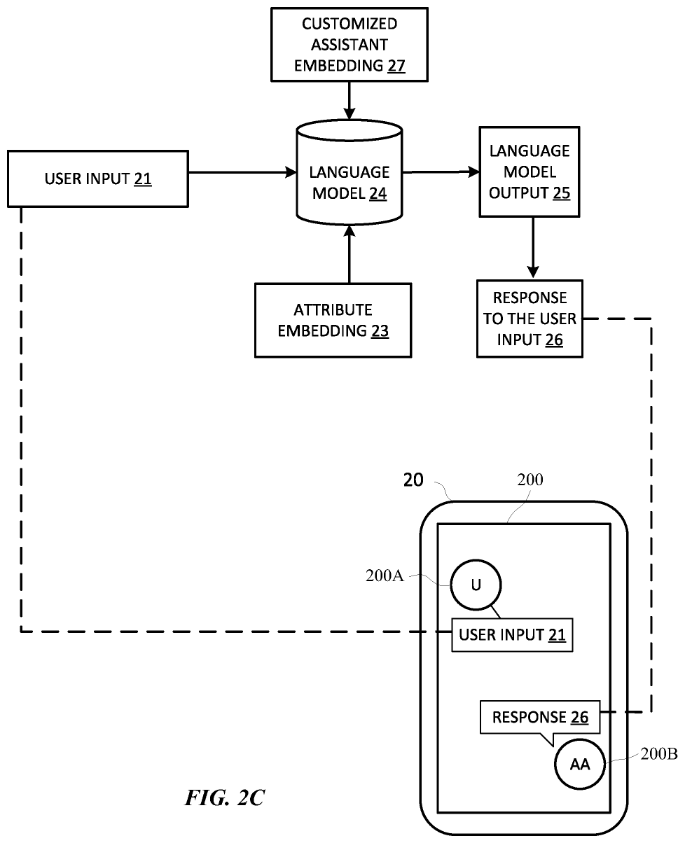

FIG. 2A depicts an example process of utilizing a language model in assisting a human-to-computer dialog, in accordance with various implementations. FIG. 2B depicts another example process of utilizing a language model in assisting a human-to-computer dialog in FIG. 2A, in accordance with various implementations. FIG. 2C depicts yet another example process of utilizing a language model in assisting a human-to-computer dialog in FIG. 2A, in accordance with various implementations.

As a non-limiting example, referring to FIG. 2A, a user 200A of a client device 20 can type in a user input 21 to the client device 20 via a user interface 200 of an application (e.g., the automated assistant application 110, graphically represented by a symbol or avatar 200B at the user interface 200) installed at the client device 20, where such user input 21 can be displayed at the user interface 200. The user input 21 can be processed, so that attribute information 201 (if there is any) of the user 200A can be determined from the user input 21. The attribute information 201 of the user 200A can be processed to generate an attribute embedding 23 that numerically represents the attribute information 201 of the user 200A. Alternatively or additionally, the attribute information 201 of the user 200A and an initial attribute embedding 22 can be processed to generate the attribute embedding 23 that numerically represents the attribute information 201 of the user 200A. For example, the attribute information 201 can be utilized to update the initial attribute embedding 22, to generate the attribute embedding 23. For instance, an input embedding can be generated based on processing, using the attribute embedding generation model, only the attribute information 201. Further, the attribute embedding 23 can be generated as a function of the input embedding and the initial attribute embedding 22. For example, the attribute embedding 23 can be generated as a weighted average of the input embedding and the initial attribute embedding, weighting the initial attribute embedding 22 more heavily.

A language model 24 can be used to process both the user input 21 and the attribute embedding 23 as input, to generate a language model output 25. Based on the language model output 25, the client device 20 (e.g., via the application such as automated assistant 110) can generate a response 26 that is responsive to the user input 21 of the user 200A, where the response 26 can be displayed at the user interface 200 of the client device 20 as a statement of the automated assistant 200B. For example, the fulfillment engine 117 can utilize the language model output 25 to generate the response 26. It is noted that instead of or in addition to being displayed at the user interface 200 of the client device 20, the response 26 can be audibly rendered to the user 200A via one or more hardware speakers of the client device 20.

Referring now to FIG. 2B, instead of or in addition to the attribute information 201 being determined from the user input 21 as in FIG. 2A, the attribute information 201 can be determined from a user account 202. The user account 202 can be an account of the client device 20, of the automated assistant, or of another application accessible by the client device 20 (or the automated assistant). The user account 202 can include attribute information of the user 200A.

Referring to FIG. 2C, in addition to the user input 21 and the attribute embedding 23, the language model 24 can process a customized assistant embedding 27, to generate the language model output 25, where based on such language model output 25, the client device 20 can generate and display the response 26 at the user interface 200 of the client device 20. The customized assistant embedding 27 can be in the same embedding space as the attribute embedding 23, where the customized assistant embedding 27 can numerically represent one or more features or characteristics of the client device 20 (or the automated assistant that is visually represented by the symbol 200B). Alternatively or additionally, the customized assistant embedding 27 can numerically represent a relationship between the user 200A and the client device 20 (or the automated assistant that is visually represented by the symbol 200B).

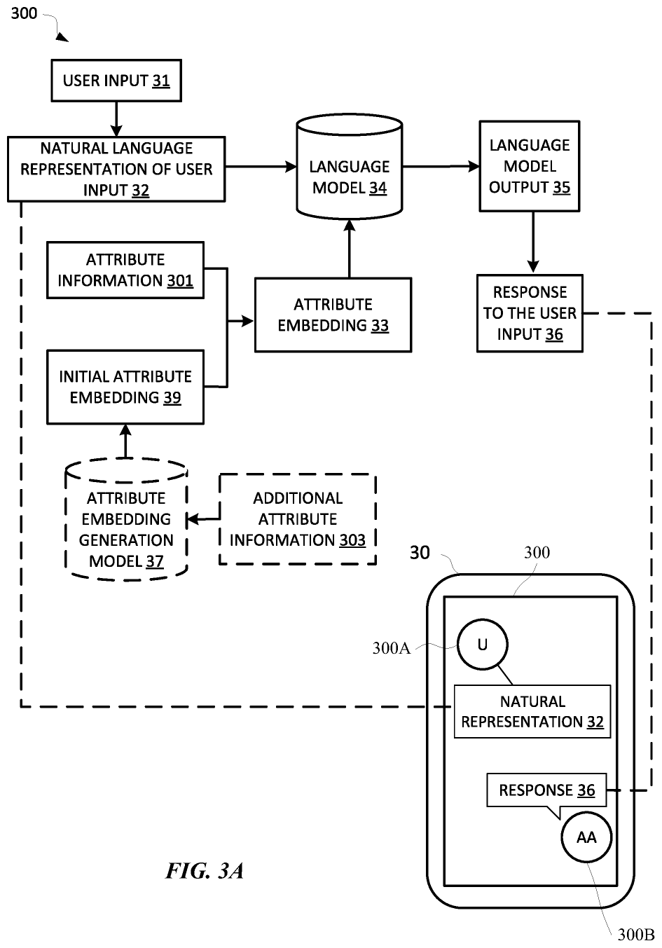

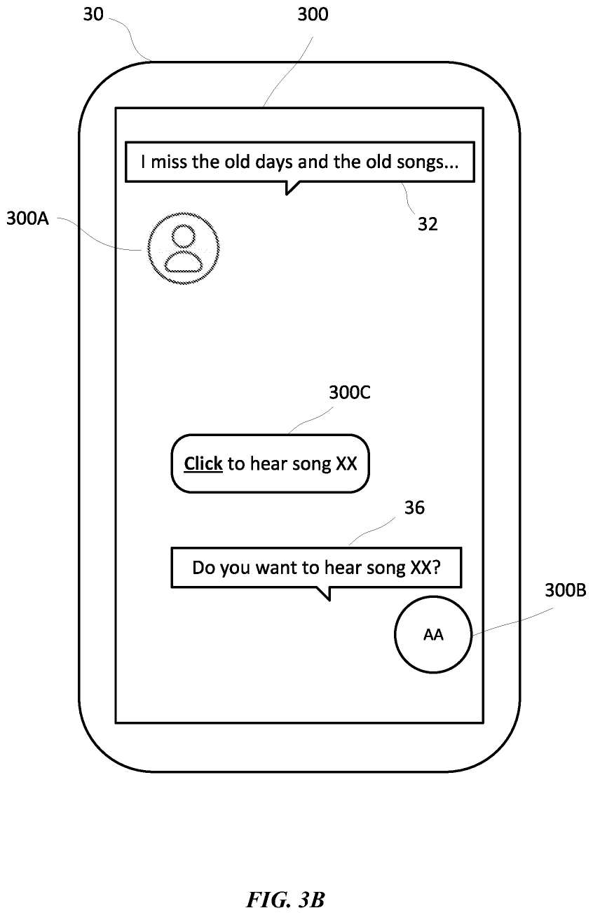

FIG. 3A depicts another example process of utilizing a language model in assisting a human-to-computer dialog, in accordance with various implementations. FIG. 3B depicts an enlarged view of a user interface in FIG. 3A, in accordance with various implementations. As shown in FIG. 3A, in various implementations, a client device 20 can receive a spoken utterance of a user 300A as a user input 31. The user input 31 can be processed (e.g., using the ASR engine 111 in FIG. 1) to generate a natural language representation/recognition 32 of the user input 31. Optionally, the natural language representation/recognition 32 of the user input 31 can be displayed at a user interface 300 of an automated assistant that is visually represented using a symbol (e.g., “AA”, or an avatar) 300B.

In response to receiving the user input 31, attribute information 301 of the user 300A can be determined or retrieved. For instance, the attribute information 301 can be determined from the user input 31 or the natural language representation 32. Alternatively or additionally, the attribute information 301 can be determined based on account information or authorized user data of the user 300A. The attribute information 301 and/or an initial attribute embedding 39 can be processed to generate an attribute embedding 33. Further, a language model 34 can process both the natural language representation 32 of the user input 31 and the attribute embedding 33, to generate a language model output 35. Based on the language model output 35, a response 36 that is responsive to the user input can be generated and displayed at the user interface 300 of the client device 30. It is noted that the initial attribute embedding 39 can be generated as output, of an attribute embedding generation model 37, that is generated based on processing additional attribute information 303 that is different from the attribute information 301. Further, in some implementations the attribute information 301 is also processed, using the attribute embedding generation model 37 and without processing of the additional attribute information 303, to generate an additional embedding. In some of those implementations, the attribute embedding 33 is determined based on averaging or otherwise combining the additional embedding and the initial attribute embedding 39.

Referring to FIG. 3B, as a practical example of FIG. 3A, the user 300A can provide a spoken utterance “I miss the old days and the old songs” as the user input 31 to an application visually represented using the symbol 300B. In this example, a natural language recognition 32 of the spoken utterance “I miss the old days and the old songs” can be displayed and the attribute information 301 can be determined, in response to receiving the user input 31. The attribute information 301 can be determined, for instance, from a user profile and/or historical chat history shared by the application (that is visually represented using the symbol 300B), to include or indicate that the user 300A is a female in her 30s. The attribute information 301 can be processed to generate the attribute embedding 33. The language model 34 can be utilized to process the natural language representation 32 (e.g., “I miss the old days and the old songs”) of the user input 31, as well as the attribute embedding 33, to generate the language model output 35. Based on such language model output 35, a response 36 (e.g., “Do you want to hear song XX”) can be generated and displayed at the user interface 300 illustrated in FIG. 3B. Alternatively or additionally, based on the language model output 35 and/or the response 36, an actionable suggestion 300C can be generated and displayed at the user interface 300. For instance, the actionable suggestion 300C can be displayed as a selectable element showing natural language content of “Click to hear song XX”, where when the selectable element 300C is selected, the song XX can be played via the client device 30 for the user 300A to enjoy.

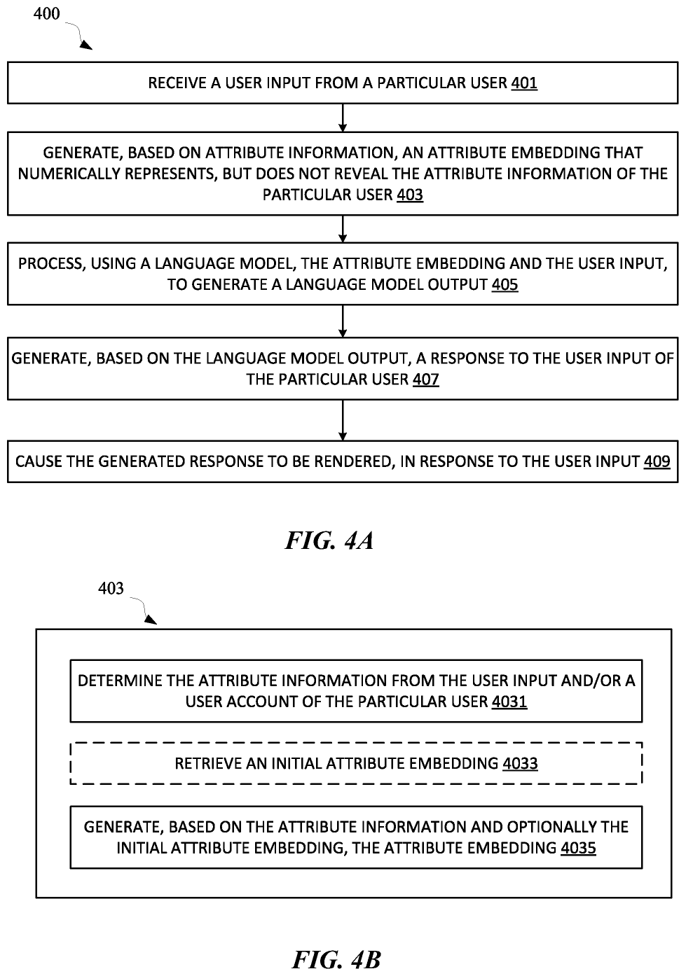

FIG. 4A illustrates a flowchart illustrating an example method 400 of utilizing a language model in assisting human-to-computer dialog(s), in accordance with various implementations. FIG. 4B illustrates a flowchart illustrating an example method of block 403 of FIG. 4A, in accordance with various implementations. For convenience, the operations of the method 400 are described with reference to a system that performs the operations. The system of method 400 includes one or more processors and/or other component(s) of a client device and/or of a server device. Moreover, while operations of the method 400 are shown in a particular order, this is not meant to be limiting. One or more operations may be reordered, omitted, or added.

Referring to FIG. 4A, in various implementations, at block 401, the system can receive, via a client device, a user input from a particular user. As a non-limiting example, the client device can be a cell phone, a laptop, a desktop, a notebook computer, a tablet, a smart TV, a messaging device, or a personal digital assistant (PDA), and the present disclosure is not limited thereto. As a non-limiting example, the user input can be, or include, a spoken utterance, and/or a typed or touch-control input. The user input can be an input that initiates a human-to-computer dialog, or can be user input provided in continuance of an ongoing human-to-computer dialog.

In various implementations, at block 403, the system can generate, based on attribute information of the particular user, an attribute embedding that numerically represents, but does not reveal, the attribute information of the particular user. In some implementations or iterations of block 403, block 403 can include sub-blocks 4031, 4033, and/or 4035 of FIG. 4B. At sub-block 4031, the system determines the attribute information from the user input and/or from other source(s) such as a user account of the particular user. At optional sub-block 4033, the system retrieves an initial attribute embedding for the particular user, such as an attribute embedding generated in a most recent iteration of performing FIG. 4A for the particular user. At sub-block 4035, the system generates the attribute embedding based on the attribute information of block 4031 and, optionally, based on the initial attribute embedding of optional block 4033. For example, the system can generate the attribute embedding by updating the initial attribute embedding, of block 4033, based on the attribute information of block 4031. For instance, the system can determine an additional embedding based on the attribute information of block 4031, then update the initial attribute embedding of block 4031 to make the initial attribute embedding closer, in embedding space, to the additional embedding.

In various implementations, at block 405, the system can process, using a language model, both the attribute embedding and the user input to generate a language model output. The language model can be, for instance, an LLM. For example, the language model can be an LLM trained based on example dialogs and corresponding attribute embeddings for those example dialogs. In some implementations, the system can process, using the language model, both the attribute embedding and the user input by: processing, using the language model, the attribute embedding to prime the language model; and processing, using the language model subsequent to priming the language model using the attribute embedding, the user input to generate the language model output.

In various implementations, at block 407, the system can generate, based on the language model output, a response to the user input. The response can be in natural language and can be audibly and/or visually rendered at block 409. In various implementations, at block 409, the system can cause the generated response to be rendered at the client device in response to the user input from the particular user. The system can proceed back to block 401 in response to receiving a further user input from the particular user.

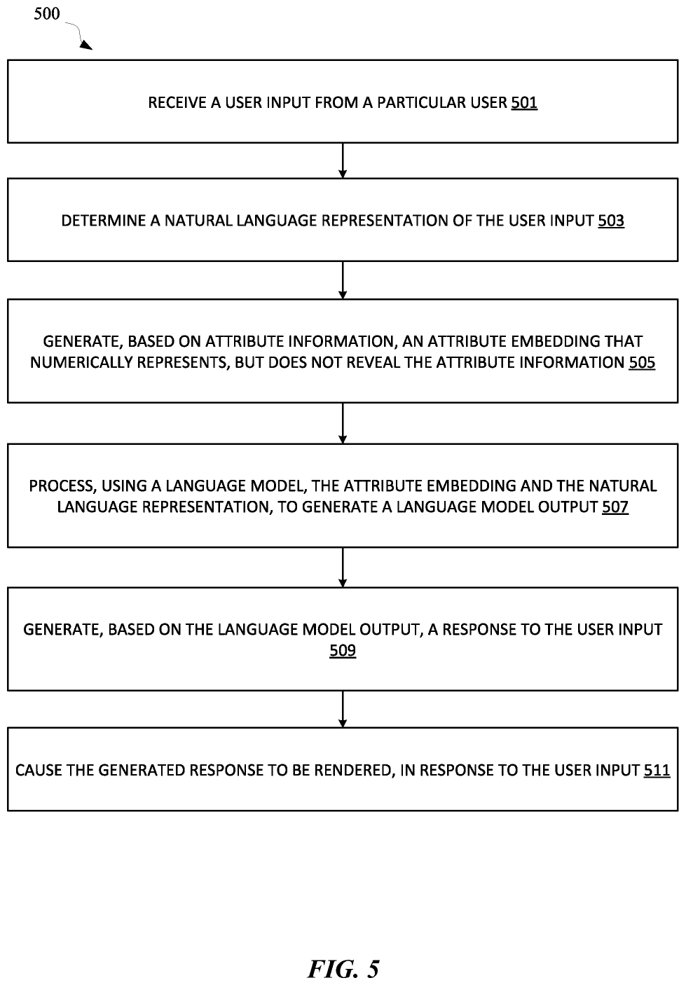

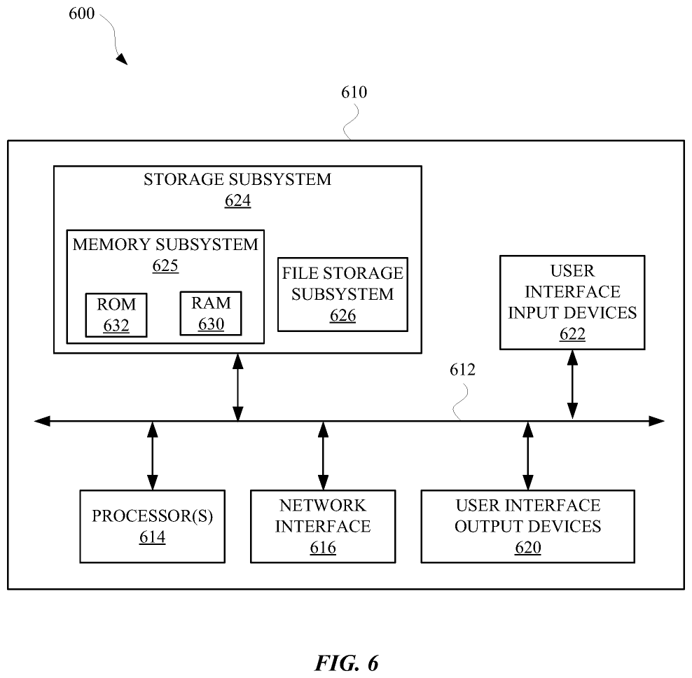

FIG. 5 is a flowchart illustrating an additional example method 500 of utilizing a language model in assisting human-to-computer dialog(s), in accordance with various implementations. For convenience, the operations of the method 500 are described with reference to a system that performs the operations. The system of method 500 includes one or more processors and/or other component(s) of a client device and/or of a server device. Moreover, while operations of the method 500 are shown in a particular order, this is not meant to be limiting. One or more operations may be reordered, omitted, or added.

In various implementations, at block 501, the system can receive, via a client device, a user input from a particular user. In various implementations, at block 503, the system can determine a natural language representation of the user input from the particular user. In various implementations, at block 505, the system can generate, based on the user input from the particular user, an attribute embedding numerically representing, but not revealing, attribute information of the particular user. In various implementations, at block 507, the system can process, using a language model, both the attribute embedding and the natural language representation to generate a language model output. In various implementations, at block 501, the system can generate, based on the language model output, a response to the user input. In various implementations, at block 501, the system can cause the generated response to be presented to the particular user via the client device.

In some implementations, the system can generate, based at least on the user input from the particular user, the attribute embedding by: retrieving an initial attribute embedding; and generating the attribute embedding by updating the initial attribute embedding based on attribute information extracted from the user input.

Optionally, the initial attribute embedding can be generated based on attribute information of the particular user extracted from a user account of the particular user. Optionally, the user account of the particular user is associated with the client device or an application of the client device. Optionally, the initial attribute embedding is a default embedding or a randomly selected embedding.

Optionally, the initial attribute embedding can be generated by an attribute embedding generation model using a plurality of instances from a plurality of users. The attribute embedding generation model can be, for instance, a neutral network, and the initial attribute embedding can be an intermediate output, or a final output, of the attribute embedding generation model.

In various implementations, the system can further receive, via the client device or the application accessible at the client device, an additional user input from the particular user. In response to receiving the additional user input, the system can determine a natural language representation of the additional user input. In response to receiving the additional user input and based on the natural language representation of the additional user input as well as the attribute embedding, the system can generate an additional attribute embedding numerically representing updated attribute information of the particular user.

In various implementations, the system can process, using the language model, both the natural language representation of the additional user input and the additional attribute embedding, to generate an additional language model output. In various implementations, in response to the additional user input and based on the additional language model output, the system can generate an additional response to the additional user input and cause the generated additional response to be presented to the particular user via the client device.

FIG. 6 is a block diagram of an example computing device 610 that may optionally be utilized to perform one or more aspects of techniques described herein. In some implementations, one or more of a client computing device, cloud-based automated assistant component(s), and/or other component(s) may comprise one or more components of the example computing device 610.

Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 624 may include the logic to perform selected aspects of the methods disclosed herein, as well as to implement various components depicted in FIGS. 1 and 2.

These software modules are generally executed by processor 614 alone or in combination with other processors. Memory 625 used in the storage subsystem 624 can include a number of memories including a main random access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computing device 610 communicate with each other as intended. Although bus subsystem 612 is shown schematically as a single bus, alternative implementations of the bus subsystem may use multiple buses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, and/or method described herein. In addition, any combination of two or more such features, systems, and/or methods, if such features, systems, and/or methods are not mutually inconsistent, is included within the scope of the present disclosure.

In various implementations, a computer-implemented method is provided and includes: receiving, via a client device, a user input from a particular user, and generating, based on attribute information provided by the particular user, an attribute embedding that numerically represents, but does not reveal, the attribute information of the particular user. In various implementations, the method can further include: processing, using a language model, both the attribute embedding and the user input to generate a language model output; generating, based on the language model output, a response to the user input; and causing the generated response to be rendered at the client device in response to the user input from the particular user.

In various implementations, processing, using the language model, both the attribute embedding and the user input to generate the language model output can include: processing, using the language model, the attribute embedding to prime the language model; and processing, using the language model subsequent to priming the language model using the attribute embedding, the user input to generate the language model output.

In various implementations, generating, based on the attribute information, the attribute embedding can include: extracting the attribute information from the user input; retrieving an initial attribute embedding associated with the client device; and generating the attribute embedding by updating the initial attribute embedding based on the attribute information of the particular user extracted from the user input. In these and other implementations, the initial attribute embedding can be generated based on additional attribute information of the particular user identified from a user account of the particular user. The user account of the particular user can be associated with the client device or an application accessible via the client device.

In various implementations, the initial attribute embedding can be generated based on processing, using an attribute embedding generation model, the additional attribute information. In various implementations, the attribute embedding generation model can be a neutral network, and the initial attribute embedding can be an intermediate output of the attribute embedding generation model. Alternatively, in some implementations, the initial attribute embedding can be a final output of the attribute embedding generation model.

In various implementations, generating the attribute embedding by updating the initial attribute embedding based on the attribute information can include: determining an additional embedding based on the attribute information; and updating the initial attribute embedding to make the initial attribute embedding closer, in embedding space, to the additional embedding.

In various implementations, the method can further include: receiving, via the client device, an additional user input from the particular user; generating, based on the additional user input from the particular user and the attribute embedding, an additional attribute embedding numerically representing, but not revealing, updated attribute information of the particular user; processing, using the language model, both the additional user input and the additional attribute embedding, to generate an additional language model output; generating, based on the additional language model output, an additional response to the additional user input; and causing the generated additional response to be presented to the particular user via the client device.

In various implementations, an additional computer-implemented method is provided and includes: receiving, via a client device, a user input from a particular user; determining a natural language representation of the user input from the particular user; generating, based on the user input from the particular user, an attribute embedding numerically representing, but not revealing, attribute information of the particular user; processing, using a language model, both the attribute embedding and the natural language representation to generate a language model output; generating, based on the language model output, a response to the user input; and causing the generated response to be presented to the particular user via the client device.

In these implementations, generating, based at least on the user input from the particular user, the attribute embedding can include: retrieving an initial attribute embedding; and generating the attribute embedding by updating the initial attribute embedding based on attribute information extracted from the user input. The initial attribute embedding can be, for instance, generated based on attribute information of the particular user extracted from a user account of the particular user, where the user account of the particular user can be associated with the client device or an application of the client device.

In some implementations, the initial attribute embedding is a default embedding or a randomly selected embedding. In some implementations, the initial attribute embedding is generated by an attribute embedding generation model using a plurality of instances collected from a plurality of users.

In some implementations, the attribute embedding generation model is a neutral network, and the initial attribute embedding is a final output, or an intermediate output, of the attribute embedding generation model.

In some implementations, the additional method can further include: receiving, via the client device, an additional user input from the particular user; determining a natural language representation of the additional user input; generating, based on the natural language representation of the additional user input and the attribute embedding, an additional attribute embedding numerically representing updated attribute information of the particular user; processing, using the language model, both the natural language representation of the additional user input and the additional attribute embedding, to generate an additional language model output; generating, based on the additional language model output, an additional response that is responsive to the additional user input; and causing the generated additional response to be presented to the particular user via the client device.

In various implementations, a system is provided and includes: one or more processors and memory storing instructions that, when executed, cause the one or more processors to perform operations of: receiving, via a client device, a user input from a particular user; generating, based on the user input from the particular user, an attribute embedding numerically representing, but not revealing, attribute information of the particular user; processing, using a language model, both the user input and the attribute embedding, to generate a language model output; generating, based on the language model output, a response to the user input; and causing the generated response to be presented to the particular user via the client device.

In various implementations of the system, the one or more processors are further configured to perform an operation of generating the attribute embedding by: extracting the attribute information from the user input; retrieving an initial attribute embedding, and generating the attribute embedding by updating the initial attribute embedding based on the attribute information of the particular user extracted from the user input. In various implementations of the system, the initial attribute embedding can be generated based on attribute information of the particular user extracted from a user account of the particular user.

In various implementations of the system, the one or more processors can be, or can include: central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform any of the aforementioned methods. Some implementations also include a computer program product including instructions executable by one or more processors to perform any of the aforementioned methods.

1. A computer-implemented method, the method comprising:
receiving a user input from a particular user, the user input being formulated via a client device;
generating, based on attribute information provided by the particular user, an attribute embedding that numerically represents, but does not reveal, the attribute information of the particular user;
processing, using a language model, both the attribute embedding and the user input to generate a language model output;
generating, based on the language model output, a response to the user input; and
causing the generated response to be rendered at the client device in response to the user input from the particular user.

2. The method of claim 1, wherein processing, using the language model, both the attribute embedding and the user input to generate the language model output comprises:
processing, using the language model, the attribute embedding to prime the language model; and
processing, using the language model subsequent to priming the language model using the attribute embedding, the user input to generate the language model output.

3. The method of claim 1, wherein generating, based on the attribute information, the attribute embedding comprises:
extracting the attribute information from the user input;
retrieving an initial attribute embedding associated with the client device; and
generating the attribute embedding by updating the initial attribute embedding based on the attribute information of the particular user extracted from the user input.

4. The method of claim 3, wherein initial attribute embedding is generated based on additional attribute information of the particular user identified from a user account of the particular user.

5. The method of claim 4, wherein the user account of the particular user is associated with the client device or an application accessible via the client device.

6. The method of claim 4 or claim 5, wherein the initial attribute embedding is generated based on processing, using an attribute embedding generation model, the additional attribute information.

7. The method of claim 6, wherein:
the attribute embedding generation model is a neutral network model, and
the initial attribute embedding is a final output of, or an intermediate output of, the attribute embedding generation model.

8. The method of claim 3, wherein generating the attribute embedding by updating the initial attribute embedding based on the attribute information comprises:
determining an additional embedding based on the attribute information; and
updating the initial attribute embedding to make the initial attribute embedding closer, in embedding space, to the additional embedding.

9. The method of claim 1, further comprising:
receiving an additional user input from the particular user, the additional user input being formulated via the client device;
generating, based on the additional user input from the particular user and the attribute embedding, an additional attribute embedding numerically representing, but not revealing, updated attribute information of the particular user;
processing, using the language model, both the additional user input and the additional attribute embedding, to generate an additional language model output;
generating, based on the additional language model output, an additional response to the additional user input; and
causing the generated additional response to be presented to the particular user via the client device.

10. A computer-implemented method, comprising:
receiving a user input from a particular user, the user input being formulated via a client device;
determining a natural language representation of the user input from the particular user;
generating, based on the user input from the particular user, an attribute embedding numerically representing, but not revealing, attribute information of the particular user;
processing, using a language model, both the attribute embedding and the natural language representation to generate a language model output;
generating, based on the language model output, a response to the user input; and
causing the generated response to be presented to the particular user via the client device.

11. The method of claim 10, wherein generating, based at least on the user input from the particular user, the attribute embedding comprises:
retrieving an initial attribute embedding; and
generating the attribute embedding by updating the initial attribute embedding based on attribute information extracted from the user input.

12. The method of claim 11, wherein the initial attribute embedding is generated based on attribute information of the particular user extracted from a user account of the particular user.

13. The method of claim 12, wherein the user account of the particular user is associated with the client device or an application of the client device.

14. The method of claim 11, wherein the initial attribute embedding is a default embedding or a randomly selected embedding.

15. The method of claim 11, wherein the initial attribute embedding is generated by an attribute embedding generation model using a plurality of instances collected from a plurality of users.

16. The method of claim 15, wherein:
the attribute embedding generation model is a neutral network, and
the initial attribute embedding is a final output, or an intermediate output, of the attribute embedding generation model.

17. The method of claim 11, further comprising:
receiving, via the client device, an additional user input from the particular user;
determining a natural language representation of the additional user input;
generating, based on the natural language representation of the additional user input and the attribute embedding, an additional attribute embedding numerically representing updated attribute information of the particular user;
processing, using the language model, both the natural language representation of the additional user input and the additional attribute embedding, to generate an additional language model output;
generating, based on the additional language model output, an additional response that is responsive to the additional user input; and
causing the generated additional response to be presented to the particular user via the client device.

18. A system, comprising:
one or more processors; and
memory storing instructions that, when executed, cause the one or more processors to:
receive a user input from a particular user;
generate, based on attribute information provided by the particular user, an attribute embedding that numerically represents, but does not reveal, the attribute information of the particular user:
process, using a language model, both the attribute embedding and the user input to generate a language model output:
generate, based on the language model output, a response to the user input; and
cause the generated response to be rendered at the client device in response to the user input from the particular user.

19. (canceled)
